(19) United States
(12) Patent Application Publication
(10) Pub. No.: US 2024/0356075 A1
(43) Pub. Date: Oct. 24, 2024

(54) ELECTROLYTE ADDITIVE, ELECTROLYTE AND LITHIUM ION SECONDARY BATTERY INCLUDING SAME

(71) Applicant: MURATA MANUFACTURING CO., LTD., Kyoto (JP)

(72) Inventors: Cheng ZHU, Shanghai (CN); Yingtao CHEN, Shanghai (CN); Haoyue ZHONG, Shanghai (CN); Manli XUE, Shanghai (CN); Hao ZHANG, Shanghai (CN)

(21) Appl. No.: 18/743,860

(22) Filed: Jun. 14, 2024

Related U.S. Application Data
(63) Continuation of application No. PCT/CN2022/123523, filed on Sep. 30, 2022.

(30) Foreign Application Priority Data
Dec. 14, 2021 (CN) 2021115255060

(51) Int. Cl. H01M 10/0567; H01M 10/0525

(52) U.S. Cl. CPC H01M 10/0567; H01M 10/0525; H01M 2300/0025

(57) ABSTRACT

An electrolyte additive, an electrolyte and a lithium ion secondary battery including same are provided. The electrolyte additive includes a first additive and a second additive, the first additive has a structure of a following formula (1):

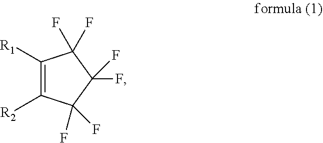

wherein R₁ and R₂ are each independently selected from fluorine; C₁-C₃ alkoxy; or phenyl optionally substituted with fluorine, C₁-C₃ alkyl, or C₁-C₃ perfluoroalkyl,
and the second additive is selected from any one of a following substances:

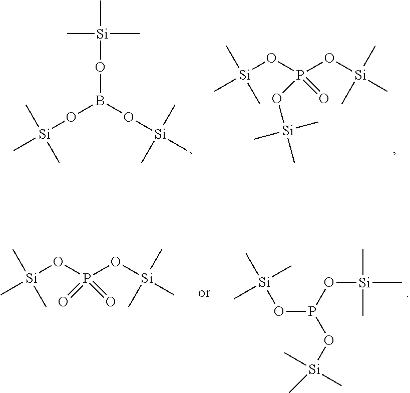

### CROSS REFERENCE TO RELATED APPLICATIONS

The present application is a continuation of PCT patent application no. PCT/CN2022/123523, filed on Sep. 30, 2022, which claims priority to Chinese patent application no. 202111525506.0, filed on Dec. 14, 2021, the entire contents of which are incorporated herein by reference.

### BACKGROUND

The present application relates to the field of lithium ion secondary batteries, and in particular, to an electrolyte additive, an electrolyte and a lithium ion secondary battery including same.

In recent years, along with the continuous development of electronic technology, demand of people for a battery apparatus supporting energy supply of an electronic device is also increasing continuously. Today, batteries capable of storing more electric quantity and capable of outputting high power are needed. Conventional lead-acid batteries and nickel-hydrogen batteries and the like have been unable to meet the requirements of novel electronic products such as mobile devices such as smart phones and fixed devices such as electric power storage systems and the like.

Therefore, lithium ion batteries have attracted people's wide attention. In the development process of lithium ion batteries, the capacity and performance thereof have been improved effectively.

The electrolyte is a carrier for ion transfer in a lithium ion battery, and is generally composed of an organic solvent, a functional additive and a lithium salt. During charging and discharging, the electrolyte is decomposed, a solid electrolyte interface film (SEI film) passivation layer which is electrically insulated but allows for conduction of lithium ions is formed on the surface of an electrode, and the lithium ions can be freely intercalated and de-intercalated by passing through the passivation layer; meanwhile, the passivation layer is solvophobic, so that the passivation layer can stably exist in the solvent, and solvent molecules cannot pass through the passivation layer, thereby effectively preventing co-embedding of the solvent molecules from damaging an electrode material. Therefore, the formation of the SEI film is crucial to the performance of the lithium ion battery. An SEI film with stable film formation, uniform thickness and good conduction of lithium ions can significantly improve the reversible capacity of the lithium ion battery, and prolong the lifetime of the lithium ion battery. The SEI film formed by an electrochemical reaction imposes strict requirements on a reaction potential, and the introduction of a functional additive, particularly a film-forming additive, is generally considered as an effective method for improving the performance of the battery. On the one hand, the functional additive can participate in the formation of the SEI film, and in addition, the functional additive can provide a lower reaction potential, so that the functional additive is subjected to an electrochemical reaction preferentially than the solvent, thereby effectively inhibiting decomposition of the solvent. The addition of even some functional additives can protect functional additives which play a major role, and form the SEI film subjected to a multi-stage reaction.

The most commonly used functional additives in lithium ion secondary batteries are vinylene carbonate (VC) and fluorinated ethylene carbonate (fluoroethylene carbonate, FEC) and the like. After a fluorine element is introduced into the FEC, the Lowest Unoccupied Molecular Orbital (LUMO) has lower energy, and FEC is easily reduced and generally is considered as a relatively ideal negative electrode film-forming additive. Meanwhile, since the fluorine element has a very small atomic radius, the solubility of the additive and the wettability between an electrode and a separator can be improved, thereby improving the temperature-resistance characteristics of the battery. However, the FEC essentially still belongs to a carbonate compound, and gas is inevitably generated when the FEC is subjected to a reaction and is decomposed, causing the battery to expand, thereby deteriorating the performance of the battery, and this phenomenon is more serious especially when the FEC is used in large quantities. Therefore, it is particularly important to solve the problems of expansion and performance deterioration of a lithium ion secondary battery caused by gas generation of carbonate additives such as FEC.

### SUMMARY

The present application relates to providing, in an embodiment, an electrolyte additive, an electrolyte including the electrolyte additive, and a lithium ion secondary battery including the electrolyte, so as to solve the problems of expansion and performance deterioration of a lithium ion secondary battery caused by gas generation of carbonate additives such as FEC.

According to one aspect of the present application, provided is an electrolyte additive, the electrolyte additive includes a first additive and a second additive, the first additive has a structure as shown by the following formula (1):

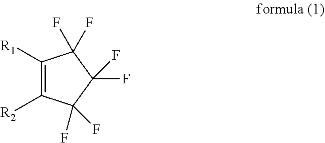

wherein R₁ and R₂ are each independently selected from fluorine; C₁-C₃ alkoxy; or phenyl optionally substituted with fluorine, C₁-C₃ alkyl, or C₁-C₃ perfluoroalkyl,
and the second additive is selected from any one of the following substances:

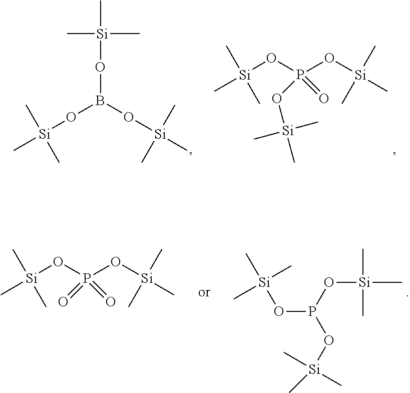

Further, in the described electrolyte additive, R₁ and R₂ are each independently selected from phenyl substituted with C₁-C₃ perfluoroalkyl.

Further, in the described electrolyte additive, R₁ and R₂ are each independently selected from phenyl substituted with trifluoromethyl.

Further, in the described electrolyte additive, the second additive is

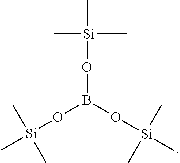

Further, in the described electrolyte additive, the first additive is selected from any one of the following substances:

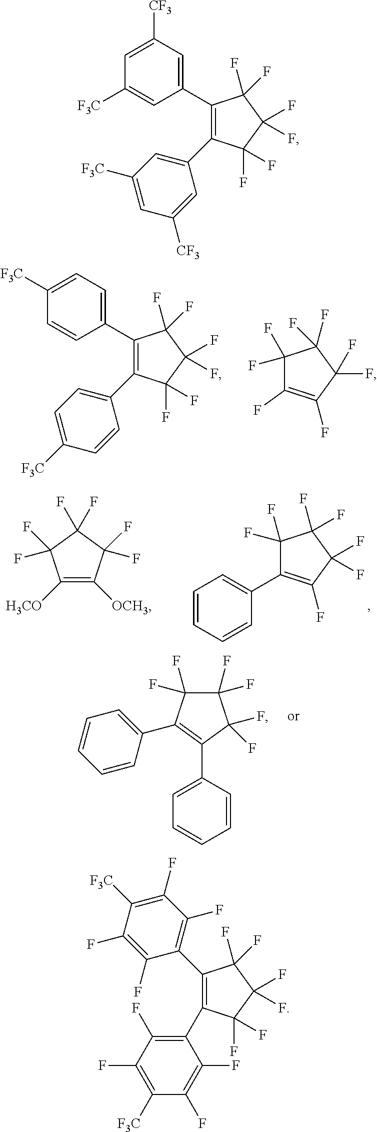

Further, in the described electrolyte additive, the weight ratio of the first additive to the second additive is in the range of 1:3 to 4:3.

According to another aspect of the present application, provided is an electrolyte, including an organic solvent, a lithium salt and the electrolyte additive as described above.

Further, in the described electrolyte, based on 100 parts by weight of the organic solvent and the lithium salt, the amount of the first additive is in the range of 0.1 parts by weight to 3.0 parts by weight, and preferably, the amount of the first additive is in the range of 0.1 parts by weight to 2.0 parts by weight.

Further, in the described electrolyte, based on 100 parts by weight of the organic solvent and the lithium salt, the amount of the second additive is in the range of 0.1 parts by weight to 3.0 parts by weight, and preferably, the amount of the second additive is in the range of 0.1 parts by weight to 2.0 parts by weight.

According to yet another aspect of the present application, provided is a lithium ion secondary battery, including: a positive electrode, a negative electrode, a separator, and the electrolyte as described above.

The electrolyte additive, the electrolyte including the electrolyte additive, and the lithium ion secondary battery including the electrolyte, in an embodiment, inhibit expansion of the lithium ion secondary battery caused by gas generation, improve the composition of an SEI film, effectively reduce the internal resistance of the lithium ion secondary battery, and improve the cycle performance of the lithium ion secondary battery.

### BRIEF DESCRIPTION OF THE FIGURES

FIG. 1 shows a graph of high-temperature cycle performance of Example 2 and Comparative Examples 1-3.

FIG. 2 shows a graph of post-cycle impedance of Example 2 and Comparative Examples 1-3.

### DETAILED DESCRIPTION

It is to be noted that examples in the present application and features in the examples may be combined with one another without conflicts. Hereinafter, the present application will be described in further detail including with reference to examples according to an embodiment. The following examples are merely exemplary, and are not intended to limit the scope of protection of the present application.

As explained in the Background, fluorinated ethylene carbonate (FEC) and the like is generally used as a negative electrode film-forming additive in a lithium ion secondary battery. However, when carbonate additives such as FEC are used, there are problems of expansion and performance deterioration of the lithium ion secondary battery caused by gas generation. In view of such problems, the present application, in an embodiment, provides an electrolyte additive, the electrolyte additive includes a first additive and a second additive, the first additive has a structure as shown by the following formula (1):

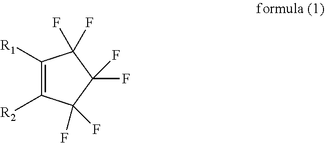

wherein R₁ and R₂ are each independently selected from fluorine; C₁-C₃ alkoxy; or phenyl optionally substituted with fluorine, C₁-C₃ alkyl, or C₁-C₃ perfluoroalkyl, and the second additive is selected from any one of the following substances:

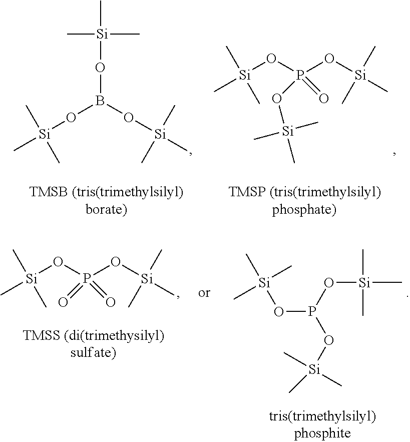

In an embodiment, a perfluorocyclopentene compound is used as the first additive, the perfluorocyclopentene compound uses a fluorine atom to replace an oxygen atom and a carbonyl in additives in the prior art; and when the additive is decomposed, the fluorine ion replaces carbonyl groups such as CO and/or CO₂, thereby avoiding gas generation. Meanwhile, by changing the functional group of a substituent at the alkenyl position, a reaction potential of the electrolyte additive can be effectively regulated, thereby regulating the decomposition potential of other functional additives or solvents, which facilitates a protection mechanism of the additives and the solvents. Meanwhile, expansion of the lithium ion secondary battery due to gas generation can be effectively suppressed, and the safety characteristics of the lithium ion secondary battery can be improved. The introduction of the perfluoro skeleton structure can effectively improve the wettability and temperature characteristics of the electrolyte. In addition, the change of the functional group of the substituent at the alkenyl position of the first additive can form a multi-stage decomposition reaction, thereby achieving a synergistic effect.

The first additive, in an embodiment, is decomposed on the surface of a negative electrode of the lithium ion secondary battery to form a solid electrolyte interface film (SEI film) preferentially than the solvent, to protect the solvent and an electrode while forming LiF. LiF, as an important inorganic salt component in the SEI film, can modify the SEI film, so that the lithium ion conductivity can be improved, and the cycle stability of the lithium ion secondary battery can be improved.

Carbon-based groups such as CO and/or CO₂ are not generated when the first additive is decomposed, the problems of expansion and performance deterioration of the lithium ion secondary battery caused by gas generation of carbonate additives such as FEC in the prior art can be effectively solved, and the high-temperature performance of the lithium ion secondary battery can be improved.

The second additive, in an embodiment, can consume hydrofluoric acid and excessive fluorine ions existing in the electrolyte, protect the electrode of the lithium ion secondary battery, reduce the internal resistance of the lithium ion secondary battery, meanwhile, consume the excessive fluorine ions to reduce the content of LiF, and can reduce the thickness of the SEI film, thereby improving the lithium ion conductivity.

According to an embodiment, a combination of the first additive and the second additive of the present application can achieve a synergistic effect. For example, by using a combination of the perfluorocyclopentene compound as the first additive and silicon-based borate, silicon-based sulfate, silicon-based phosphate or silicon-based phosphite as the second additive, on the one hand, the first additive is decomposed to generate LiF, which can modify the SEI film, thereby improving the cycle stability of the lithium ion secondary battery. On the other hand, the second additive consumes excessive LiF, which reduces the internal resistance of the lithium ion secondary battery; moreover, LiF supplemented by the first additive into the system can effectively inhibit a Si-F reaction, and inhibit the effect of deteriorating cycles of the silicon-based borate, silicon-based sulfate, silicon-based phosphate or silicon-based phosphite as the second additive at a high temperature. The combination of the first additive and the second additive can improve the wettability of the electrolyte, suppress expansion of the lithium ion secondary battery due to gas generation, reduce the internal resistance of the lithium ion secondary battery, and improve the cycle characteristics and high-temperature performance of the lithium ion secondary battery.

A reaction mechanism of the first additive and the second additive is as follows: the first additive is a perfluorocyclopentene compound, and is an unsaturated fluorine-containing compound structure, can connect functional groups with an electron-donating property or an electron-withdrawing property, can improve the electrochemical reactivity of the parent structure of cyclopentene, making it easy to obtain electrons, such that a solid electrolyte interface film (SEI film) is formed on the surface of the negative electrode. Meanwhile, the second additive is a structure of silicon-based borate, silicon-based sulfate, silicon-based phosphate or silicon-based phosphite; after the second additive obtains electrons, the Si—O bond will be broken to produce CH₃Si—, which reacts with fluorine ions to produce F—Si compounds, thereby effectively controlling the concentration of hydrofluoric acid existing in the electrolyte and the thickness of the SEI film. The first additive and the second additive have very good matching properties, and can simultaneously allow for occurrence of a film-forming reaction in an initial charging and discharging process. The first additive and the second additive have a synergistic effect, which improves the composition of the SEI film, effectively reduces the internal resistance of the lithium ion secondary battery, and improves the cycle performance of the lithium ion secondary battery.

The present application, in an embodiment, provides an electrolyte additive, a synergistic effect is generated by using a combination of a first additive and a second additive, the first additive generates necessary LiF when an electrolyte is decomposed, to stabilize an interface of an SEI film, thereby improving high-temperature performance of a lithium ion secondary battery. The second additive consumes hydrofluoric acid and excessive fluorine ions existing in the electrolyte, to decrease the impedance of the lithium ion secondary battery.

In an embodiment, in formula (1), R₁ and R₂ are each independently selected from phenyl substituted with C₁-C₃ perfluoroalkyl, and preferably, R₁ and R₂ are each independently selected from phenyl substituted with trifluoromethyl. When R₁ and R₂ are each independently selected from the described groups, the first additive can effectively regulate the reaction potential of the electrolyte additive, better generate a film-forming reaction, and can better improve the cycle performance of the lithium ion secondary battery.

In an embodiment, in order to better interact with the second additive to form a negative electrode protective layer with a good stability and better improve the cycle performance of the lithium ion secondary battery, the first additive may be selected from any one of the following substances:

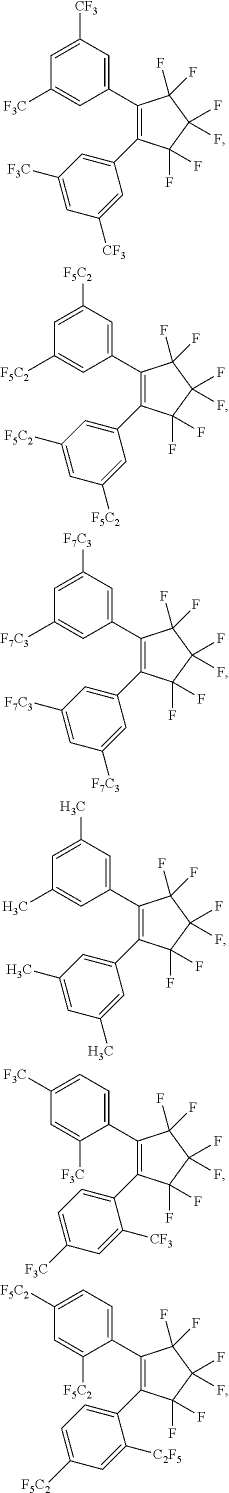

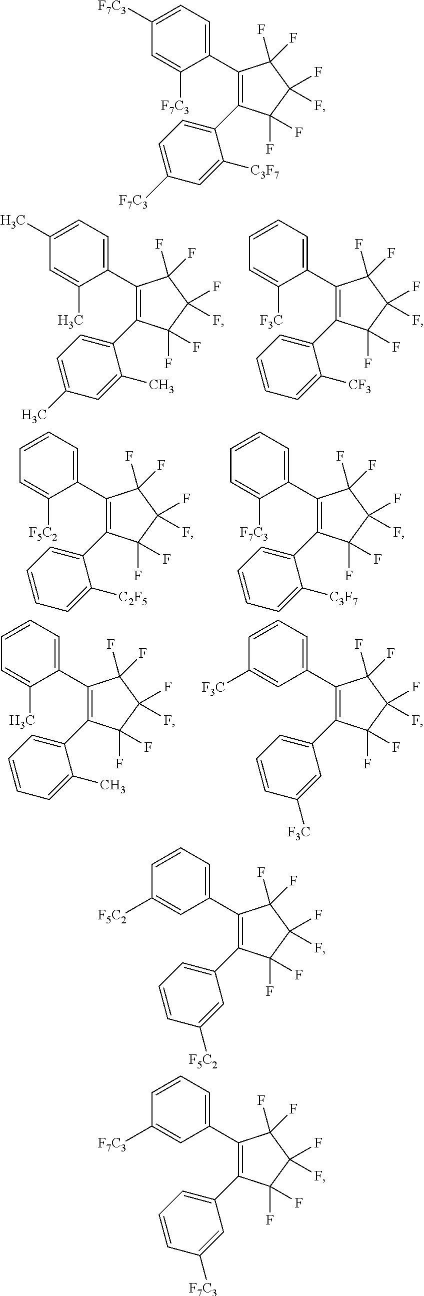

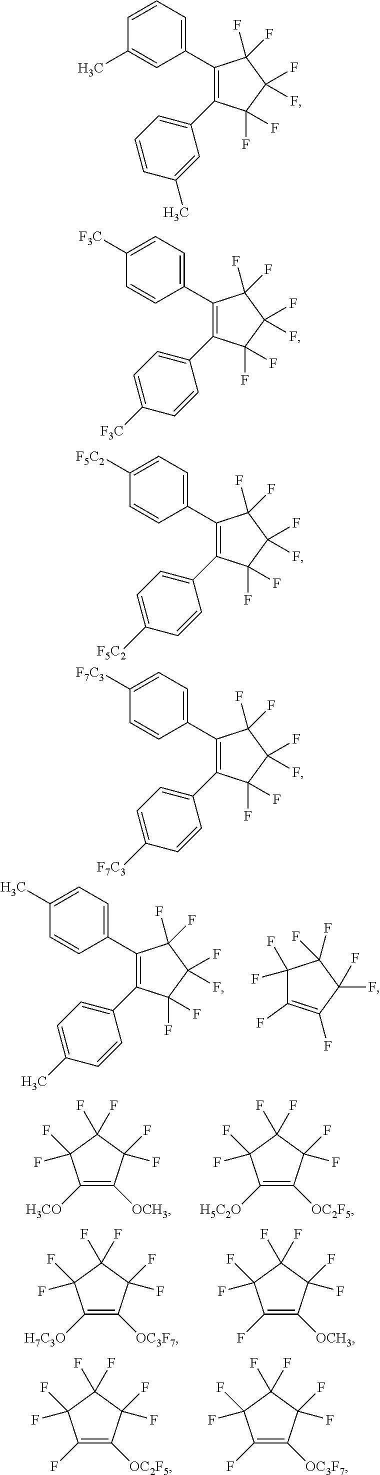

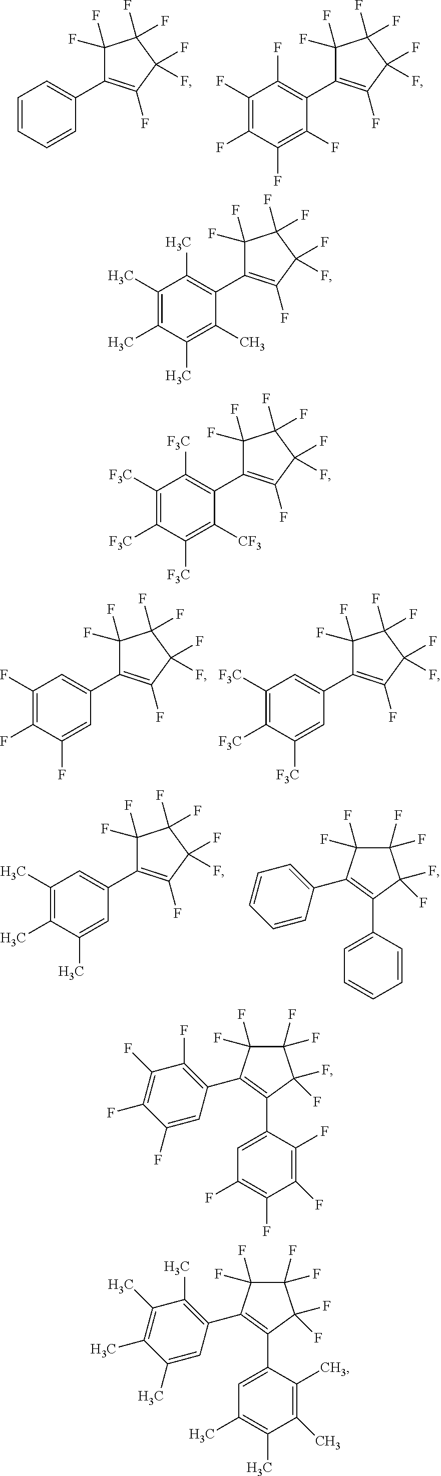

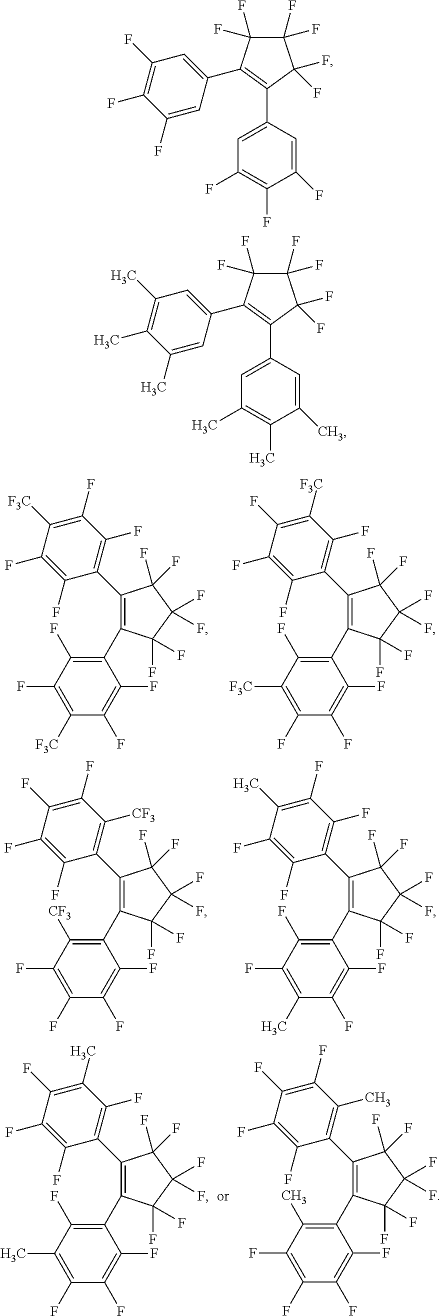

In an embodiment, in order to better interact with the first additive to form an electrode protective layer with good stability and less impedance and more effectively decrease the internal resistance of the lithium ion secondary battery, the second additive may be preferentially selected as

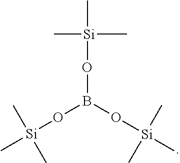

In an embodiment, the weight ratio of the first additive to the second additive is in the range of 1:3 to 4:3, preferably, in the range of 1:3 to 1:1, and most preferably, in the range of 1:2 to 1:1. By controlling the weight ratio of the first additive to the second additive to be within the described range, the wettability of the electrolyte can be further improved, the internal resistance of the lithium ion secondary battery can be further reduced, and the cycle characteristics and high-temperature performance of the lithium ion secondary battery can be further improved.

In another embodiment, provided is an electrolyte, including an organic solvent, a lithium salt and the electrolyte additive as described above. Since the electrolyte additive is included, the electrolyte can effectively form a stable SEI film on the surface of the negative electrode during initial charging and discharging of the battery, thereby suppressing the decomposition of the solvent. Furthermore, the electrolyte is used to inhibit expansion of the lithium ion secondary battery caused by gas generation, effectively reduce the internal resistance of the lithium ion secondary battery, and improve the cycle performance of the lithium ion secondary battery.

In an embodiment, in the electrolyte, based on 100 parts by weight of the organic solvent and the lithium salt, the amount of the first additive is in the range of 0.1 parts by weight to 3.0 parts by weight, and preferably, in the range of 0.1 parts by weight to 2.0 parts by weight, more preferably, in the range of 0.5 parts by weight to 2.0 parts by weight, further preferably, in the range of 0.5 parts by weight to 1.8 parts by weight, further preferably, in the range of 0.5 parts by weight to 1.5 parts by weight, and most preferably, in the range of 0.5 parts by weight to 1.0 part by weight. By controlling the amount of the first additive to be within the range above, the cycle characteristics and high-temperature performance of the lithium ion secondary battery can be better improved.

For example, based on 100 parts by weight of the organic solvent and the lithium salt, the amount of the first additive in the electrolyte may be in the following ranges: 0.15 parts by weight to 2.5 parts by weight, 0.2 parts by weight to 2.3 parts by weight, 0.25 parts by weight to 2.1 parts by weight, 0.3 parts by weight to 1.9 parts by weight, 0.35 parts by weight to 1.7 parts by weight, 0.4 parts by weight to 1.5 parts by weight, 0.45 parts by weight to 1.3 parts by weight, 0.5 parts by weight to 1.1 parts by weight, 0.55 parts by weight to 0.9 parts by weight, 0.6 parts by weight to 0.8 parts by weight, 0.12 parts by weight to 0.95 parts by weight, 0.14 parts by weight to 0.75 parts by weight, 0.16 parts by weight to 0.55 parts by weight, or 0.18 parts by weight to 0.45 parts by weight.

In an embodiment, in the electrolyte, based on 100 parts by weight of the organic solvent and the lithium salt, the amount of the second additive is in the range of 0.1 parts by weight to 3.0 parts by weight, and preferably, in the range of 0.1 parts by weight to 2.0 parts by weight, more preferably, in the range of 0.5 parts by weight to 2.0 parts by weight, further preferably, in the range of 0.5 parts by weight to 1.8 parts by weight, further preferably, in the range of 0.5 parts by weight to 1.5 parts by weight, and most preferably, in the range of 1.0 parts by weight to 1.5 parts by weight. By controlling the amount of the second additive to be within the range above, the internal resistance of the lithium ion secondary battery can be better reduced.

For example, based on 100 parts by weight of the organic solvent and the lithium salt, the amount of the second additive in the electrolyte may be in the following ranges: 0.15 parts by weight to 2.5 parts by weight, 0.2 parts by weight to 2.3 parts by weight, 0.25 parts by weight to 2.1 parts by weight, 0.3 parts by weight to 1.9 parts by weight, 0.35 parts by weight to 1.7 parts by weight, 0.4 parts by weight to 1.5 parts by weight, 0.45 parts by weight to 1.3 parts by weight, 0.5 parts by weight to 1.1 parts by weight, 0.55 parts by weight to 0.9 parts by weight, 0.6 parts by weight to 0.8 parts by weight, 0.12 parts by weight to 0.95 parts by weight, 0.14 parts by weight to 0.75 parts by weight, 0.16 parts by weight to 0.55 parts by weight, or 0.18 parts by weight to 0.45 parts by weight.

In an embodiment, the organic solvent may be any organic solvent for an electrolyte up to now. Examples of the organic solvent include, but are not limited to, linear carbonates or cyclic carbonates, such as ethylene carbonate, propylene carbonate, butylene carbonate, diethyl carbonate, dimethyl carbonate, ethyl methyl carbonate, dipropyl carbonate, fluorinated ethylene carbonate; ethers such as 1,2-dimethoxyethane, 1,2-diethoxyethane, γ-butyrolactone, tetrahydrofuran, 2-methyltetrahydrofuran, 1,3-dioxolane, 4-methyl-1,3-dioxolane, diethyl ether; sulfones, such as sulfolane, methyl sulfolane; nitriles, such as acetonitrile, propionitrile, acrylonitrile; and esters, such as acetates, propionates, butyrates, and the like. These organic solvents may be used alone, or a plurality of organic solvents may be used in combination. In an embodiment, preferred organic solvents include one or more of ethylene carbonate, propylene carbonate, butylene carbonate, fluorinated ethylene carbonate, diethyl carbonate, dimethyl carbonate, ethyl methyl carbonate and dipropyl carbonate. In a preferred embodiment, at least one carbonate is used as the organic solvent of the electrolyte. In a preferred embodiment, at least one linear carbonate and at least one cyclic carbonate are used together as the organic solvent of the electrolyte.

The electrolyte includes any suitable type of lithium salt, and including known lithium salts which can be used for an electrolyte of a lithium battery. Examples of the lithium salt may include: one or more of LiCl, LiBr, LiPF₆, LiBF₄, LiAsF₆, LiClO₄, LiB(C₆H₅)₄, LiCH₃SO₃, LiCF₃SO₃, LiN(SO₂F)₂, LiN(CF₃SO₂)₂, LiC(CF₃SO₂)₃, LiAlCl₄ and Li₂SiF₆.

In another embodiment, provided is a lithium ion secondary battery, including: a positive electrode, a negative electrode, a separator, and the electrolyte as described above. Since the lithium ion secondary battery uses the electrolyte as described above, in an embodiment, the lithium ion secondary battery has reduced internal resistance and improved cycle performance.

The positive electrode includes a positive electrode current collector and a positive electrode active material layer including a positive electrode active material. The positive electrode active material layer is formed on both surfaces of the positive electrode current collector. A metal foil such as an aluminum foil, a nickel foil, or a stainless steel foil may be used as the positive electrode current collector.

The positive electrode active material layer contains one or more positive electrode materials capable of intercalating and de-intercalating lithium ions as the positive electrode active material, and may contain, as necessary, another material, for example, a positive electrode binder and/or a positive electrode conductive agent.

Preferably, the positive electrode material is a lithium-containing compound. Examples of such a lithium-containing compound include a lithium-transition metal composite oxide, a lithium-transition metal phosphate compound, and the like. The lithium-transition metal composite oxide is an oxide containing Li and one or two or more transition metal elements as constituent elements, and the lithium-transition metal phosphate compound is a phosphate compound containing Li and one or two or more transition metal elements as constituent elements. The transition metal element is advantageously one or more of Co, Ni, Mn and Fe, and the like.

Examples of the lithium-transition metal composite oxide may include, for example, LiCoO₂ and LiNiO₂, and the like. Examples of the lithium-transition metal phosphate compound may include, for example, LiFePO₄ and LiFe₁₋ᵤMnᵤPO₄ (0<u<1), and the like.

The negative electrode includes, in an embodiment, a negative electrode current collector and a negative electrode active material layer including a negative electrode active material. The negative electrode active material layer is formed on both surfaces of the negative electrode current collector. A metal foil such as a copper (Cu) foil, a nickel foil, or a stainless steel foil may be used as the negative electrode current collector.

The negative electrode active material layer includes one or more negative electrode materials capable of intercalating and de-intercalating lithium ions as the negative electrode active material, and may include, as necessary, another material, for example, a negative electrode binder and/or a negative electrode conductive agent.

The negative electrode active material may be selected from one or more of lithium metal, a lithium alloy, a carbon material, silicon or tin and oxides thereof.

The separator, in an embodiment, is used to separate the positive electrode from the negative electrode in the battery, and allow lithium ions to pass therethrough, while preventing current short-circuiting due to contact between the positive electrode and the negative electrode. The separator is, for example, a porous membrane formed of a synthetic resin or ceramic, and may be a laminated membrane in which two or more porous membranes are laminated. Examples of the synthetic resin includes, for example, polytetrafluoroethylene, polypropylene and polyethylene, and the like.

In an embodiment, when the lithium ion secondary battery is charged, for example, lithium ions are de-intercalated from the positive electrode and are intercalated into the negative electrode through the electrolyte impregnated in the separator. When the lithium ion secondary battery is discharged, for example, lithium ions are de-intercalated from the negative electrode and are intercalated into the positive electrode through the electrolyte impregnated in the separator.

Hereinafter, the present application will be described in further detail including with examples according to an embodiment, and these examples cannot be understood as limiting the scope of protection of the present application.

### EXAMPLES

### Example 1

### Preparation of Positive Electrode

95.5 g of a positive electrode active material, i.e. lithium nickel cobaltate, 2.5 g of conductive carbon black and 1.9 g of polyvinylidene fluoride and 0.1 g of polyvinylpyrrolidone dispersant were mixed to obtain a positive electrode mixture, and the obtained mixture was dispersed in N-methylpyrrolidone to obtain a positive electrode mixture slurry. Subsequently, the obtained positive electrode mixture slurry was uniformly coated onto an aluminum foil to obtain a positive electrode active material layer, the positive electrode active material layer was dried, and a punch forming process was used to form a positive electrode sheet.

### Preparation of Negative Electrode

95.85 g of a mixture of silicon suboxide (SiOₓ, 1<x<2) and graphite powder, 1.0 g of Super P conductive agent, 3.15 g of CMC (sodium carboxymethyl cellulose) binder and SBR (styrene butadiene rubber), and an appropriate amount of water were stirred, to prepare a negative electrode mixture slurry. Subsequently, the obtained negative electrode mixture slurry was uniformly coated onto a copper foil to obtain a negative electrode active material layer, the negative electrode active material layer was dried, and a punch forming process was used to form a negative electrode sheet.

### Preparation of Electrolyte

20 g of ethylene carbonate, 62 g of dimethyl carbonate and 18 g of lithium hexafluorophosphate were mixed to prepare a basic electrolyte. 0.1 g of a first additive represented by formula (1-1) and 0.1 g of a second additive represented by TMSB were added to the electrolyte, and stirred until uniform, and then the electrolyte was added into a battery to prepare a CR2016 button battery.

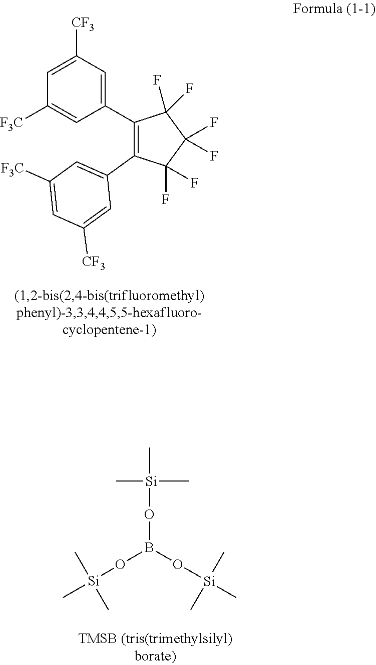

### Assembly of Battery

The CR2016 button battery was assembled in a dry laboratory. The positive electrode sheet prepared by the steps above was used as a positive electrode, the negative electrode sheet was used as a negative electrode, and the electrolyte prepared in Example 1 was used as an electrolyte.

The positive electrode, the negative electrode, the separator and a battery housing of the button battery were assembled. After the battery was assembled, the battery was allowed to stand still for 24 hours for aging, thereby obtaining the button battery.

### Example 2

A button battery was prepared by using the same method as that in Example 1, and the differences lie in that: 20 g of ethylene carbonate, 62 g of dimethyl carbonate and 18 g of lithium hexafluorophosphate were mixed to prepare a basic electrolyte; and 1.0 g of a first additive represented by formula (1-1) and 1.0 g of a second additive represented by TMSB were added to the electrolyte, and stirred until uniform, and then the electrolyte was added into a battery to prepare a CR2016 button battery.

### Example 3

A button battery was prepared by using the same method as that in Example 1, and the differences lie in that: 20 g of ethylene carbonate, 62 g of dimethyl carbonate and 18 g of lithium hexafluorophosphate were mixed to prepare a basic electrolyte; and 0.5 g of a first additive represented by formula (1-1) and 1.5 g of a second additive represented by TMSB were added to the electrolyte, and stirred until uniform, and then the electrolyte was added into a battery to prepare a CR2016 button battery.

### Example 4

A button battery was prepared by using the same method as that in Example 1, and the differences lie in that: 20 g of ethylene carbonate, 62 g of dimethyl carbonate and 18 g of lithium hexafluorophosphate were mixed to prepare a basic electrolyte; and 2.0 g of a first additive represented by formula (1-1) and 1.5 g of a second additive represented by TMSB were added to the electrolyte, and stirred until uniform, and then the electrolyte was added into a battery to prepare a CR2016 button battery.

### Example 5

A button battery was prepared by using the same method as that in Example 1, and the differences lie in that: 20 g of ethylene carbonate, 62 g of dimethyl carbonate and 18 g of lithium hexafluorophosphate were mixed to prepare a basic electrolyte; and 3.0 g of a first additive represented by formula (1-1) and 3.0 g of a second additive represented by TMSB were added to the electrolyte, and stirred until uniform, and then the electrolyte was added into a battery to prepare a CR2016 button battery.

### Example 6

A button battery was prepared by using the same method as that in Example 1, and the differences lie in that: 20 g of ethylene carbonate, 62 g of dimethyl carbonate and 18 g of lithium hexafluorophosphate were mixed to prepare a basic electrolyte; and 1.0 g of a first additive represented by formula (1-2) and 1.0 g of a second additive represented by TMSP were added to the electrolyte, and stirred until uniform, and then the electrolyte was added into a battery to prepare a CR2016 button battery.

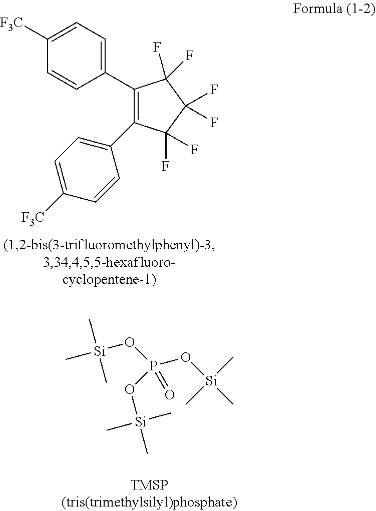

### Example 7

A button battery was prepared by using the same method as that in Example 1, and the differences lie in that: 20 g of ethylene carbonate, 62 g of dimethyl carbonate and 18 g of lithium hexafluorophosphate were mixed to prepare a basic electrolyte; and 2.0 g of a first additive represented by formula (1-2) and 1.5 g of a second additive represented by TMSP were added to the electrolyte, and stirred until uniform, and then the electrolyte was added into a battery to prepare a CR2016 button battery.

### Example 8

A button battery was prepared by using the same method as that in Example 1, and the differences lie in that: 20 g of ethylene carbonate, 62 g of dimethyl carbonate and 18 g of lithium hexafluorophosphate were mixed to prepare a basic electrolyte; and 3.0 g of a first additive represented by formula (1-2) and 3.0 g of a second additive represented by TMSP were added to the electrolyte, and stirred until uniform, and then the electrolyte was added into a battery to prepare a CR2016 button battery.

### Example 9

A button battery was prepared by using the same method as that in Example 1, and the differences lie in that: 20 g of ethylene carbonate, 62 g of dimethyl carbonate and 18 g of lithium hexafluorophosphate were mixed to prepare a basic electrolyte; and 1.0 g of a first additive represented by formula (1-1) and 1.0 g of a second additive represented by TMSP were added to the electrolyte, and stirred until uniform, and then the electrolyte was added into a battery to prepare a CR2016 button battery.

### Example 10

A button battery was prepared by using the same method as that in Example 1, and the differences lie in that: 20 g of ethylene carbonate, 62 g of dimethyl carbonate and 18 g of lithium hexafluorophosphate were mixed to prepare a basic electrolyte; and 1.0 g of a first additive represented by formula (1-2) and 1.0 g of a second additive represented by TMSB were added to the electrolyte, and stirred until uniform, and then the electrolyte was added into a battery to prepare a CR2016 button battery.

### Comparative Example 1

A button battery was prepared by using the same method as that in Example 1, and the differences lie in that: 20 g of ethylene carbonate, 62 g of dimethyl carbonate and 18 g of lithium hexafluorophosphate were mixed to prepare a basic electrolyte; and the basic electrolyte was added into a battery to prepare a CR2016 button battery.

### Comparative Example 2

A button battery was prepared by using the same method as that in Example 1, and the differences lie in that: 20 g of ethylene carbonate, 62 g of dimethyl carbonate and 18 g of lithium hexafluorophosphate were mixed to prepare a basic electrolyte; and 2.0 g of a first additive represented by formula (1-1) was added to the electrolyte, and stirred until uniform, and then the electrolyte was added into a battery to prepare a CR2016 button battery.

### Comparative Example 3

A button battery was prepared by using the same method as that in Example 1, and the differences lie in that: 20 g of ethylene carbonate, 62 g of dimethyl carbonate and 18 g of lithium hexafluorophosphate were mixed to prepare a basic electrolyte; and 2.0 g of a second additive represented by TMSB was added to the electrolyte, and stirred until uniform, and then the electrolyte was added into a battery to prepare a CR2016 button battery.

### Comparative Example 4

A button battery was prepared by using the same method as that in Example 1, and the differences lie in that: 20 g of ethylene carbonate, 62 g of dimethyl carbonate and 18 g of lithium hexafluorophosphate were mixed to prepare a basic electrolyte; and 2.0 g of a first additive represented by formula (1-2) was added to the electrolyte, and stirred until uniform, and then the electrolyte was added into a battery to prepare a CR2016 button battery.

### Test of Battery Performance

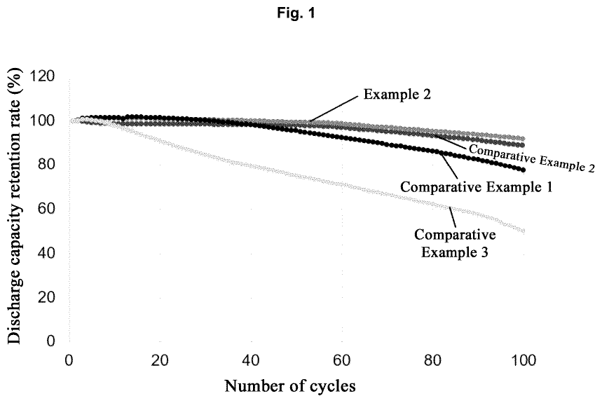

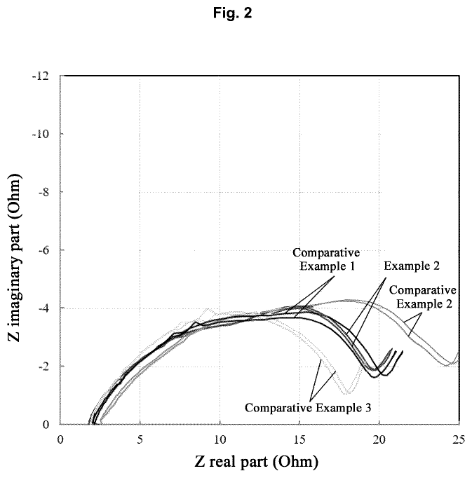

The lithium nickel cobaltate button batteries in Examples 1-10 and Comparative Examples 1-4 were subjected to a charge and discharge test and an impedance test at room temperature at a voltage between 2.75 V and 4.3 V. The batteries in the Examples and Comparative Examples above were first subjected to one cycle test of 0.1 C at room temperature, and then subjected to a cycle test of 1 C charging and 1 C discharging under the condition of 60° C. for 100 times to determine the cycle retention rates of the batteries, and finally subjected to one charging test of 1 C under the condition of 60° C. to determine the impedance values of the batteries. The experimental results are shown in Table 1 below and FIG. 1 and FIG. 2.

TABLE 1
Results of battery performance tests

| | | Addition | | Addition | | |
|---|---|---|---|---|---|---|
| | Type of | amount of | Type of | amount of | Cycle | Post-cycle |
| Experiment | the first | the first | the second | the second | retention | impedance |
| No. | additive | additive | additive | additive | rate | (Ω) |
| Example 1 | Formula (1-1) | 0.1% | TMSB | 0.1% | 87.0% | 21.7 |
| Example 2 | Formula (1-1) | 1.0% | TMSB | 1.0% | 91.7% | 19.6 |
| Example 3 | Formula (1-1) | 0.5% | TMSB | 1.5% | 90.2% | 19.1 |
| Example 4 | Formula (1-1) | 2.0% | TMSB | 1.5% | 89.9% | 19.0 |
| Example 5 | Formula (1-1) | 3.0% | TMSB | 3.0% | 82.4% | 22.2 |
| Example 6 | Formula (1-2) | 1.0% | TMSP | 1.0% | 87.1% | 21.4 |
| Example 7 | Formula (1-2) | 2.0% | TMSP | 1.5% | 87.9% | 21.9 |
| Example 8 | Formula (1-2) | 3.0% | TMSP | 3.0% | 82.6% | 22.1 |
| Example 9 | Formula (1-1) | 1.0% | TMSP | 1.0% | 90.7% | 22.8 |
| Example 10 | Formula (1-2) | 1.0% | TMSB | 1.0% | 88.7% | 19.4 |
| Comparative | None | Not | None | Not | 77.2% | 20.2 |
| Example 1 | | added | | added | | |
| Comparative | Formula (1-1) | 2.0% | None | Not | 89.1% | 24.5 |
| Example 2 | | | | added | | |
| Comparative | None | Not | TMSB | 2.0% | 50.3% | 18.0 |
| Example 3 | | added | | | | |
| Comparative | Formula (1-2) | 2.0% | None | Not | 83.1% | 23.1 |
| Example 4 | | | | added | | |

In Table 1, “addition amount of the first additive” and “addition amount of the second additive” are both weight percentages based on the total weight of the basic electrolyte.

By comparing the results of Example 2 with those of Comparative Example 2, it can be seen that compared with Comparative Example 2 in which only the first additive was added, the battery in Example 2 in which electrolyte additives include a combination of the first additive and the second additive has a higher cycle retention rate and lower post-cycle impedance. By comparing the results of Example 2 with those of Comparative Example 3, it can be seen that compared with Comparative Example 3 in which only the second additive was added, the battery in Example 2 in which electrolyte additives include a combination of the first additive and the second additive has a significantly higher cycle retention rate and a slightly high post-cycle impedance. By comparing the results of Example 2 with those of Comparative Example 1, it can be seen that compared with Comparative Example 1 in which any electrolyte additive was not added, the battery in Example 2 in which electrolyte additives include a combination of the first additive and the second additive has a higher cycle retention rate and lower post-cycle impedance.

By comparing the results of Example 6 with those of Comparative Example 4, it can be seen that compared with Comparative Example 4 in which only the first additive was added, the battery in Example 6 in which electrolyte additives include a combination of the first additive and the second additive has a higher cycle retention rate and lower post-cycle impedance. By comparing the results of Example 6 with those of Comparative Example 1, it can be seen that compared with Comparative Example 1 in which any electrolyte additive was not added, the battery in Example 6 in which electrolyte additives include a combination of the first additive and the second additive has a higher cycle retention rate and slightly high post-cycle impedance.

By comparing the results of Comparative Example 1 with those of Comparative Example 2, it can be seen that by adding the first additive, the cycle retention rate of the battery can be improved, but the post-cycle impedance is larger. By comparing the results of Comparative Example 1 with those of Comparative Example 3, it can be seen that by adding the second additive, the post-cycle impedance of the battery can be reduced, but the cycle retention rate is significantly reduced.

Hence, it can be seen that by adding the first additive alone, the cycle retention rate of the battery can be improved, but the post-cycle impedance is larger and by adding the second additive alone, the post-cycle impedance of the battery can be reduced, but the cycle retention rate is significantly reduced.

By comparing the results of Examples 1-10 with those of Comparative Example 1, it can be seen that compared with Comparative Example 1 in which any electrolyte additive was not added, Examples 1-10 in which electrolyte additives include a combination of the first additive and the second additive can ensure that the battery has a higher cycle retention ratio while the post-cycle impedance is reduced or not greatly increased. In particular, by comparing the results of Examples 2-4 and Example 10 with those of Comparative Example 1, it can be seen that compared with Comparative Example 1 in which any electrolyte additive was not added, the batteries in Examples 2-4 and Example 10 in which electrolyte additives include a combination of the first additive and the second additive have a higher cycle retention rate and lower post-cycle impedance. Hence, it can be seen that compared with Comparative Example 1, Examples 2-4 and Example 10 in which electrolyte additives include a combination of the first additive and the second additive have better effects, and achieve optimization of both the cycle retention rate and the post-cycle impedance.

By comparing the results of Examples 2-4 and Example 9 with those of Comparative Example 2, it can be seen that compared with Comparative Example 2 in which only the first additive was added, the batteries in Examples 2-4 and Example 9 in which electrolyte additives include a combination of the first additive and the second additive have a higher cycle retention rate and lower post-cycle impedance. Hence, it can be seen that compared with Comparative Example 2, Examples 2-4 and Example 9 in which electrolyte additives include a combination of the first additive and the second additive not only decrease the post-cycle impedance but also achieve further improvement of the cycle retention rate.

By comparing the results of Examples 1-5 with those of Comparative Example 3, it can be seen that compared with Comparative Example 3 in which only the second additive was added, the batteries in Examples 1-5 in which electrolyte additives include a combination of the first additive and the second additive greatly improve the cycle retention rate while maintaining lower post-cycle impedance.

By comparing the results of Example 6, Example 7 and Example 10 with those of Comparative Example 4, it can be seen that compared with Comparative Example 4 in which only the first additive was added, Example 6, Example 7 and Example 10 in which electrolyte additives include a combination of the first additive and the second additive not only decrease the post-cycle impedance but also achieve further improvement of the cycle retention rate.

By comparing the results of Examples 2-3 and Example 9 with those of Comparative Example 2 and by comparing the results of Example 6 and Example 10 with those of Comparative Example 4, it can be seen that with the same total amount of additives, compared with the situation of using the first additive alone, combined use of the first additive and the second additive can improve the cycle retention rate of the battery and can reduce the post-cycle impedance of the battery.

Hence, it can be seen that compared with the situation where any electrolyte additive is not added and the situations where the first additive or the second additive is added alone, the present technology can produce a synergistic effect by using a combination of the first additive and the second additive, so as to obtain a better balance between the cycle retention ratio and post-cycle impedance of the battery.

It can be seen from the described battery performance test results that the present technology exhibits excellent effects in terms of both the cycle retention rate and the post-cycle impedance of a battery by combining two additives; therefore, the electrolyte additive effectively reduces the internal resistance of the lithium ion secondary battery and improves the cycle performance of the lithium ion secondary battery according to an embodiment.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. An electrolyte additive comprising a first additive and a second additive, the first additive has a structure of a following formula (1): 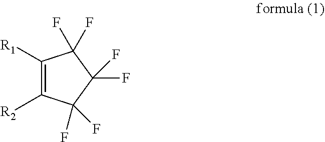
wherein R₁ and R₂ are each independently selected from fluorine; C₁-C₃ alkoxy; or phenyl optionally substituted with fluorine, C₁-C₃ alkyl, or C₁-C₃ perfluoroalkyl,
the second additive is selected from any one of the following substances:

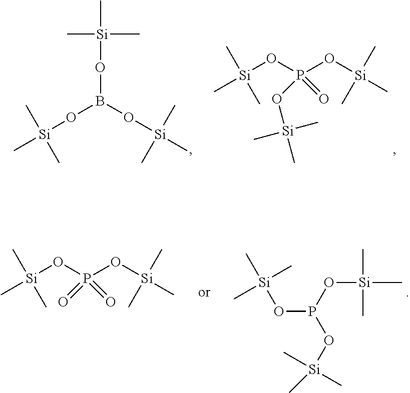

2. The electrolyte additive according to claim 1, wherein R₁ and R₂ are each independently selected from phenyl substituted with C₁-C₃ perfluoroalkyl.

3. The electrolyte additive according to claim 2, wherein R₁ and R₂ are each independently selected from phenyl substituted with trifluoromethyl.

4. The electrolyte additive according to any one of claims 1-3, wherein the second additive is

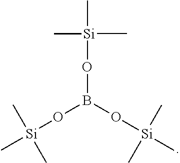

5. The electrolyte additive according to claim 1, wherein the first additive is selected from any one of the following substances:

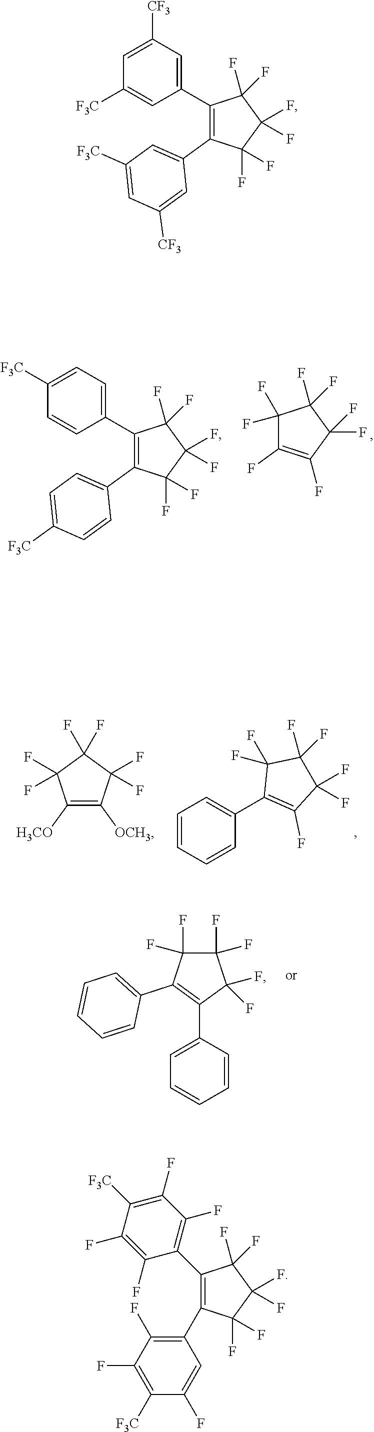

6. The electrolyte additive according to claim 1, wherein a weight ratio of the first additive to the second additive is in a range of 1:3 to 4:3.

7. An electrolyte, comprising an organic solvent, a lithium salt, and the electrolyte additive according to claim 1.

8. The electrolyte according to claim 7, wherein based on 100 parts by weight of the organic solvent and the lithium salt, an amount of the first additive is in a range of 0.1 parts by weight to 3.0 parts by weight.

9. The electrolyte according to claim 8, wherein the amount of the first additive is in a range of 0.1 parts by weight to 2.0 parts by weight.

10. The electrolyte according to claim 7, wherein based on 100 parts by weight of the organic solvent and the lithium salt, an amount of the second additive is in a range of 0.1 parts by weight to 3.0 parts by weight.

11. The electrolyte according to claim 10, the amount of the second additive is in a range of 0.1 parts by weight to 2.0 parts by weight.

12. A lithium ion secondary battery, comprising:
a positive electrode,
a negative electrode,
a separator, and
the electrolyte according to claim 7.
